(19) United States
(12) Patent Application Publication
(10) Pub. No.: US 2022/0402537 A1
(43) Pub. Date: Dec. 22, 2022

(54) CUSTOMIZABLE TROLLEY

(71) Applicant: Flipkart Internet Private Limited, Bengaluru (IN)

(72) Inventors: Varuna KAKATHKAR, Karkala (IN); Tridev KUNDU, Kolkata (IN); Shamaila Sara HYE, Mysore (IN)

(73) Assignee: Flipkart Internet Private Limited, Bengaluru (IN)

(21) Appl. No.: 17/841,295

(22) Filed: Jun. 15, 2022

(30) Foreign Application Priority Data
Jun. 16, 2021 (IN) 202141026854

(51) Int. Cl. B62B 3/00; B62B 5/06; B62B 3/02

(52) U.S. Cl. CPC B62B 3/005; B62B 5/06; B62B 3/02

(57) ABSTRACT

The present disclosure provides a customizable trolley to improve the Space Productivity Index (SPI) in Last Mile Large (LML) delivery hubs. The customizable trolley [100] comprises at least one base [102]. The customizable trolley [100] also comprises a set of connecting rods [106], wherein each connecting rod of the set of connecting rods [106] is coupled to at least one corner of the at least one base [102, and each connected rod comprises of a plurality of grooves. Further, the customizable trolley [100] comprises a set of clamps [110], wherein each clamp of the set of clamps [110] are detachably attached to at least one groove of the plurality of grooves. Furthermore, the customizable trolley [100] comprises a set of adjustable separators [108] detachably attached to the set of clamps [110].

### TECHNICAL FIELD

The present disclosure generally relates to the field of supply chain system, and more particularly, to improve the Space Productivity Index (SPI) in Last Mile Large (LML) delivery hubs through verticalization trolley design and development.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In LML (Last Mile Large) Supply chain, available space in a delivery hub determines the throughput that the delivery hub generates. Bigger the available space in the delivery hub, higher is the throughput. Last Mile experts design delivery hubs which generates higher throughput with lesser space.

SPI (Space Productivity Index) is one of the key metrics used in the LML supply chain to measure how efficiently a LML delivery hub is designed. SPI gives the space required to process a shipment. Lower the SPI, more the number of shipments that can be processed in a LML Delivery hub and higher will be its throughput per unit shipment cost. Before implementation of this disclosure, any higher throughput requirement due to organic demand increase was fulfilled by bringing in additional hub space which resulted in high fixed cost for the supply chain. For instance, if there was a sudden increase in orders, due to say a flash sale, then additional hub space was procured to meet this increase in demand. This is not however, an efficient solution and there exists a need in this area of technology to solve this problem while meeting dynamically increasing demand with the available infrastructure.

### SUMMARY

This section is provided to introduce certain aspects of the present disclosure in a simplified form that are further described below in the detailed description. This summary is not intended to identify the key features or the scope of the claimed subject matter.

The customizable trolley comprises at least one base. The customizable trolley also comprises a set of connecting rods, wherein each connecting rod of the set of connecting rods is coupled to at least one corner of the at least one base, and each connected rod comprises of a plurality of grooves. Further, the customizable trolley comprises a set of clamps, wherein each clamp of the set of clamps are detachably attached to at least one groove of the plurality of grooves. Furthermore, the customizable trolley comprises a set of adjustable separators detachably attached to the set of clamps.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure.

FIG. 1 illustrates an exemplary diagram of a working implementation of a customizable trolley to improve the Space Productivity Index (SPI) in Last Mile Large (LML) delivery hubs, in accordance with exemplary embodiments of the present disclosure.

FIG. 2 illustrates an exemplary diagram of a customizable trolley to improve the Space Productivity Index (SPI) in Last Mile Large (LML) delivery hubs, in accordance with exemplary embodiments of the present disclosure.

The foregoing shall be more apparent from the following more detailed description of the embodiments of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As disclosed in the background section, it was challenging to process more shipments within the available facility, when the demand in the route was on higher side. So, in order to cater the fluctuating demand needs within the available facility and to utilize the space in an optimized manner, there was a need to introduce new approach for storing the shipments in the LML hubs. The present disclosure was designed and conceptualized to provide space saving solution by enabling the flexible design for the vertical storage of the shipments ensuring the better SPI.

In order to overcome at least some of the limitations of the prior known solutions, the present disclosure provides a space saving solution by enabling the flexible design for the vertical storage of the shipments for ensuring better SPI. The present disclosure also introduces vertical racks in a delivery hub for staging products so that PPP (Parts per pallets) for the product can be increased from existing assumptions of 4 to 20 with better material handling and efficient storage.

The present disclosure is further explained in detail below with reference now to the diagrams.

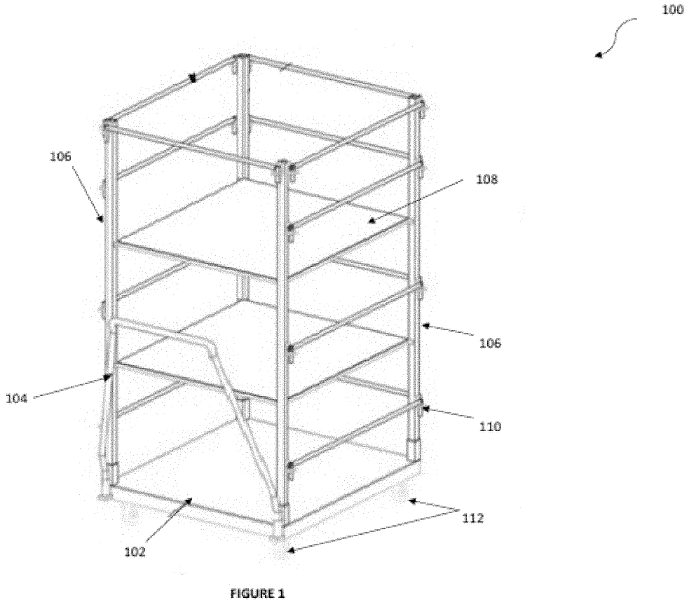

Referring to FIG. 1, an exemplary drawing with working implementation of a customizable trolley to improve the Space Productivity Index (SPI) in Last Mile Large (LML) delivery hubs, in accordance with exemplary embodiments of the present disclosure is shown.

As shown in FIG. 1, the customizable trolley comprises at least one base [102], a side support handles [104], a set of connecting rods [106], a set of adjustable separators [108], and a set of clamps [110]. The at least one base [102] is connected to the set of connecting rods [106]. Each connecting rod is coupled to at least one corner of the at least one base [102]. For instance, as shown in FIG. 1, the base [102] has four corners and thus a set of four connecting rods are connected to the base [102], one rod from among the four connecting rods [106] connected to the base [102] at one of the four corners. Further, the set of connecting rods [106] are perpendicular to the base [102]. Each connecting rod [106] comprises of a plurality of grooves. Grooves are in the form of a cavity or depression on the surface of the connecting rods [106].

The set of clamps [110] can be detachably attached to at least one groove of the plurality of grooves. The set of adjustable separators [108] are detachably attached to the set of clamps [110].

The set of side support handles [104] are mounted on at least one connecting rod [106] of the set of connecting rods [106] for moving the shipments.

The customizable trolley [100] further comprises a set of wheels [112] that makes the trolley [100] mobile, hence providing flexibility of placement and reduction in material handling and movement time. The set of wheels [112] include at least a plurality of castor wheels. This allows the customizable trolley to be parked and used as a storage trolley as well. The rear castor wheels with lock feature is used, so that the trolley [100] can remain static even when the floor surface is not flat. For instance, the trolley [100] can be used as static storage pallet because of the locking feature of rear castor wheel.

As shown in the FIG. 1, by adjustable rack separator design, the trolley can accommodate products of different dimensions. For example, dimensions of the Television boxes may be different for different brands. In the prior art, it was challenging to design the trolley in such a way that it can accommodate all brands. This was solved through adjustable separator fixture arrangement of the present invention.

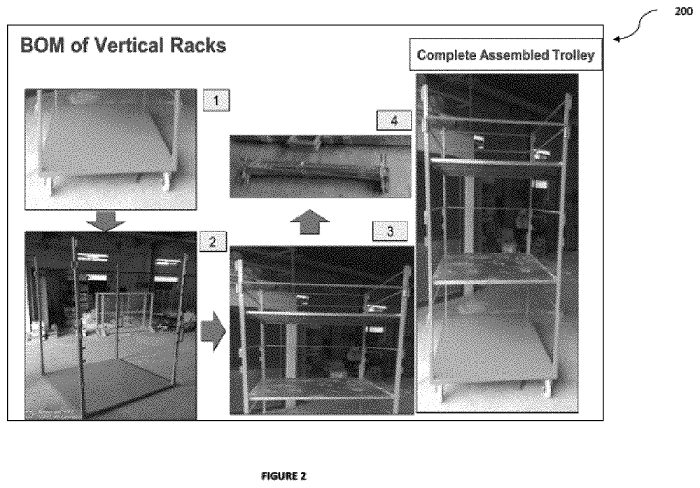

Referring to FIG. 2, an exemplary block diagram of an assembled customizable trolley [200] for improving the SPI in the LML delivery hubs is shown. Part 1 of FIG. 2 shows a base [102] and a set of connecting rods [106] attached to the base [102]. As shown, the connecting rods [106] are welded to the base [102] and are perpendicular to the base [102]. Part 1 also shows wheels [112] attached to the base [102]. Part 2 shows the set of connecting rods [106] with grooves and clamps [110] attached to the grooves. As shown in part 2, there may be multiple grooves at different points on the surface of the connecting rods [106] and the clamps [110] may be placed in any of the grooves as per the requirement.

Part 3 shows adjustable rack separators [108] placed on a set of clamps [110]. The products can be placed on the base [102] as well as on the rack separators [108]. Part 4 shows the complete assembly of the trolley [100] wherein two rack separators have been assembled. Pertinently, this entire assembly can be done without the requirement of any tool.

The customizable trolley design has the following technical and economic advantages.

### 1) Cost Benefit

The Shipment capacity of the hubs before introducing the vertical racks were approximately 25,000 shipments. However, the Shipment capacity of the hubs post introduction of the vertical racks of the present invention, came up to 30,000 shipments. Thus, the Additional Capacity created because of the vertical stacking was about 5000 shipments. Considering 10 SPI, space saved by utilizing these trolleys-5000*10=50,000 sq. ft. Assuming a rental cost of a hub of Rs. 65 per square feet, the total cost saving would be −50,000 sq. ft * 6 months of rent* 65 Rs/sq. ft ˜1.95 Cr. Thus, there is an enormous economic significance of the customizable trolley design of the present invention.

### 2) Operations Benefit

The use of the customizable trolley design results in improved stacking of shipments. As per the experiments conducted, the stacking increased from 4 per pallet (by prior solutions) to 20 per pallet (by the present invention). Further, Increased throughput by 30% was observed as more shipments can be processed in the same space. Furthermore, during unloading, there is significant reduction of time in unloading of shipments from line haul vehicle. Also, during delivery, the customizable trolleys can be used in hubs wherever possible to dock & load products.

### 3) Shipment and Operator Safety Benefit

The present invention helps in reducing the fatigue level of Material Handlers as heavy shipments can be easily moved under best ergonomic conditions. Further, the side protective guard rail of the present invention ensures no toppling of shipments. Also, the presence of lockable rear castor wheel feature of the present invention ensures trolley to remain static when it is unattended.

### 4) Being Future Ready

The modular design with adjustable separator positions of the present invention ensures that vertical racks can accommodate both existing and future design of products (such as TV) of different dimensions from various brands.

As evident from the above disclosure, the present solution provides significant technical advancement over the existing solutions by introducing the vertical racks in a delivery hub for staging TV so that PPP (Parts per pallets) for the TV can be increased from existing assumptions of 4 to 20 with better material handling and efficient storage. The present disclosure also provides a solution to the technical problem of processing more shipments within the available facility, when the demand in that route was on higher side. Also, the solution provided by the present disclosure improves stacking of shipments from 4 per pallet to 20 per pallet. Also, the present disclosure provides a throughput Increase by 30%, hence more shipments can be processed in the same available space.

While considerable emphasis has been placed herein on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

1. A customizable trolley comprising:
at least one base [102];
a set of connecting rods [106], wherein each connecting rod of the set of connecting rods [106] is coupled to at least one corner of the at least one base [102], and each connected rod comprises of a plurality of grooves;
a set of clamps [110], wherein each clamp of the set of clamps are detachably attached to at least one groove of the plurality of grooves; and
a set of adjustable separators [108] detachably attached to the set of clamps.

2. The customizable trolley as claimed in claim 1, further comprising a set of side support handles [104] mounted on at least one connecting rod of the set of connecting rods [106].

3. The customizable trolley as claimed in claim 1, further comprising a set of wheels [112] coupled to the at least one base [102].

4. The customizable trolley as claimed in claim 1, wherein the set of connecting rods [106] are perpendicular to the at least one base [102].

5. The customizable trolley as claimed in claim 3, wherein the set of wheels [112] include at least a plurality of castor wheels.
